(19) United States
(12) Patent Application Publication
(10) Pub. No.: US 2004/0030672 A1
(43) Pub. Date: Feb. 12, 2004

(54) Dynamic health metric reporting method and system

(76) Inventor: Jeffrey L Garwin, Holly Springs, NC (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/398,297

(22) PCT Filed: Oct. 9, 2001
(86) PCT No.: PCT/US01/31572

(30) Foreign Application Priority Data
Aug. 1, 2001 (US) 09890501

(51) Int. Cl. G06F 7/00

(52) U.S. Cl. 707/1

(57) ABSTRACT

A dynamic health metric reporting system for prospectively collecting data relevant to improve the utility of medical diagnostic technology, where the diagnostic technology produces digital data stored in an electronic database along with demo graphic and treatment data for individual patients. The reporting system includes the database system, database application logic for incorporating the data into the database, data from the diagnostic technology instrument(s), clinical and demographic data related to the individual patients and their medical history, statistical analysis programs for analyzing the database for clinically relevant group correlations between and among the diagnostic digital data, the clinical and demographic data, and the chances in these data with time for individual patients; and report-generating logic for generating a report that compares dynamically changing historical data for an individual patient in the database with clinically significant trends or findings based on group data from the entire database.

### RELATED APPLICATIONS

This application claims priority from pending U.S. provisional application serial no. 60/238,349, filed Oct. 6, 2000, entitled “A Dynamic Health Metric Reporting System”. This application is also a continuation-in-part of U.S. application Ser. No. 09/890,501, filed Aug. 1, 2001, which is the National Stage of International Application No. PCT/US00/02341, filed Jan. 29, 2000, which claims priority to U.S. application Ser. No. 09/241,193, filed Feb. 1, 1999, which is a continuation-in-part of U.S. application Ser. No. 08/957,648, filed Oct. 24, 1997, now U.S. Pat. No. 6,192,143.

### FIELD OF THE INVENTION

This invention relates to reporting systems, and more particularly to a method and system for developing a dynamic health metric reporting system for improving the utility of diagnostic technology used in the practice of medicine.

### BACKGROUND OF THE INVENTION

Historically, diagnosis of disease was accomplished by observation using the human senses of sight, hearing, touch, smell, and even taste, and then correlating these sensory observations with observations of other patients, and how they responded to further medical interventions. Before writing existed, a medicine man or shaman was limited to his own experience, or that passed down to him in an oral or apprenticeship tradition. With the origin of writing, and later printing, it was possible for a doctor to record his own observations, keep track of them, as well as to read the records of other doctors to gain the benefit of their experience.

Only in the second half of the 20^{th} century, with the development of the pharmaceutical industry and clinical trials, were statistical techniques applied to data in an effort to determine whether drugs were efficacious. The Harris-Kefauver Act of 1962 was the first legislation in the United States to require evaluation of the efficacy of drugs, as well as safety, for FDA approval. It was not until 1970 that “substantial evidence of efficacy” was defied to include “adequate and well-controlled” clinical studies of drugs, that in turn had to include a formal test with explicit objectives, defined selective procedures for subjects and controls, methods for observing and recording, and statistical analysis.

With statistical analysis, and prospective clinical trials, professional journals had results to publish, to inform the “guild” of doctors about which treatments worked and which ones did not. In the last quarter of the 20^{th} century, statistical techniques termed “meta-analysis” were developed to analyze data from multiple prospective clinical trials, according to rather broad categories. Despite the progress in drug trials, surgical procedures and diagnostic procedures were not rigorously validated. It was not until 1976 that the Medical Device Amendments to the Federal Food, Drug and Cosmetics Act required devices also to be judged effective before the FDA provides market approval.

It was only in the 1960s and 1970s that Alvan Feinstein and others started to develop clinical epidemiology as a field, where the goal was to systematically understand the natural history of disease and health by analyzing clinical data through time, and attempting to correlate subsequent developments with presenting signs, symptoms, or demographics. This approach is truly revolutionary, as it is dynamic.

Most medical diagnosis is static. An electrocardiogram is “normal” or it is abnormal in a particular way. If it is abnormal, the patient undergoes more static tests, presenting a series of views or “snapshots” of their health at a particular point in time. It is rare that previous electrocardiograms are available for comparison, to estimate how long an abnormality has been present, or to evaluate how stable the abnormality has been, or whether it is getting better or worse. The same goes for breast x-rays (mammograms). Even in the case of the humble stethoscope, there is no capacity to objectively compare one hearing of the heart sounds with a subsequent one, let alone draw correlations between heart sounds, treatment, and outcome. So it is not surprising that there have been very few longitudinal studies, prospective or retrospective, to correlate changes in diagnostic data or images with treatment, disease, or health. Retrospective studies are difficult, because the data are recorded so variably. Prospective studies have been difficult because each group of investigators typically works at one institution, and the largest studies are conducted by companies interested in studying the minimum number of patients necessary to gain regulatory approval to market their device, typically fewer than 1000 patients over less than a 1 year period. So the state of the art is small studies, based on the experience of small numbers of physicians, in a small number of locations.

In the event that a new diagnostic modality is invented, studies of its use are typically limited to proving that it offers an incremental improvement to existing technology, or even just proving “substantial equivalence.” Improving the understanding of how best to use the technology is left to academic researchers, often supported by companies, but far more money is spent on marketing to opinion leaders, and inducing them to adopt the new technology. If a new technology is superior to an old one (for instance a recording electronic stethoscope might be more sensitive than a physician's ears, as well as offering a means of preserving the sound of a beating heart at a particular date and time), prospective studies of large numbers of patients would be useful for understanding how heartbeat patterns change with time in healthy and sick individuals. In addition, if the recording stethoscope “hears” a wider range of vibration frequencies than the human ear, then additional information would come from “clinical epidemiology” studies of the new device.

Since, strictly speaking, clinical epidemiology is the study of the effects of external diseases on patient populations, the studies needed to improve a new device will be slightly different in focus, as they will monitor changes detected by the device in both “healthy” and diseased individuals. Accordingly, these studies are more of endemic than of epidemic conditions, and there is a need to understand what changes are indicative of improving health as well as of deteriorating health. A system focusing on dynamic (changing) health metrics (measurements and statistically derived measures of phenomena and their changes in populations) is desired.

There is also a need for improving the usefulness of medical devices. There is a strong tendency for health professionals and third party payers to believe that a medical diagnostic device is best used according to the instructions (labeling) prepared when the device is first marketed and sold. This attitude does not take into account that the medical practice environment changes, and that knowledge about the use of a device can change or improve. Therefore, a system for gathering evidence needed to improve the use of existing medical devices is also necessary.

Throughout the world, healthcare expenditures are constantly rising, and efficient use of technology is actively sought. In the United States, the vast majority of individuals do not pay directly for their own healthcare interventions: insurance companies, HMOs, and governments pay most medical diagnostic costs. But these third party payers do little research on how best to use the technology, and neither do the vast majority of physicians. However, the third party payers are very interested in seeing that their participating physician adopt the most cost-efficient practices for using diagnostic technology, to determine the existence of disease at early stages, when treatment is least expensive. Third party payers also hope to discourage physicians from treating a condition that either is not harmful or will resolve benignly on its own. The Dynamic Health Metric Reporting System that is useful in addressing these concerns is also needed.

### SUMMARY OF THE INVENTION

The present invention is a dynamic health metric reporting system for prospectively collecting data relevant to improving the utility of medical diagnostic technology, by focusing on dynamic (changing) health metrics (measurements and statistically derived measures of phenomena and their changes in populations).

In one aspect of the invention, the system collects and stores examination data for each of multiple examinations of subject bodies. The examination data from of two or more selected examination dates is compared, and differences determined, for a specific subject body. The differences between two or more examination dates are characterized and stored in a database. A report is generated that details the differences in the examination data to assist in predicting a likely course of health for the subject body.

In another aspect of the invention, the system similarly collects and stores examination data for each of multiple examinations of subject bodies. The examination data from of two or more selected examination dates is compared for a specific subject body, differences are determined and one dynamic metric is created for the subject body, and stored in a database, for each pair of examination dates compared. One or more dynamic metrics for the subject body are compared with dynamic metrics for a relevant comparison population of similarly situated subject bodies in the database and reports are generated detailing the similarities and differences in the dynamic metrics for the subject body with the dynamic metrics of similarly situated subject bodies to assist in predicting a likely course of health for the subject body.

### DETAILED DESCRIPTION OF THE INVENTION

The dynamic health metric reporting system of the present invention includes the database system, database application logic for incorporating the data into the database, data from the diagnostic technology instrument(s), clinical and demographic data related to the individual patients and their medical history, statistical analysis programs for analyzing the database for clinically relevant group correlations between and among the diagnostic digital data, the clinical and demographic data, and the changes in these data with time for individual patients; and report-generating logic for generating a report that compares historical data for an individual patient in the database with clinically significant trends or findings based on group data from the entire database.

The invention uniquely permits the acquisition of prospective data in large quantity and in consistent format, so that the data will yield insights directed to the best use of the diagnostic technology. The prospective data acquired by this invention, by virtue of its size, consistency, and digital format, allows the operator of the invention to create unique dynamic databases that provide a “moving picture” of health and development of disease, in place of disjointed snapshots. When a dynamic database reaches a sufficient critical size, both in numbers of patients and in time that each patient is followed, the report-generating logic informs doctors and third party payers about the likely health progression of a particular patient, given his or her record through time relative to the relevant patient database (i.e., a predictive instrument).

### EXAMPLE 1

### A Dynamic Health Metric Reporting System (DHMRS) for Auditory Data Related to the Heart

In this embodiment the dynamic health metric reporting system (DHMRS) collects data prospectively from doctors using electronic stethoscopes, such as the DRG Conventional Electronic Digital Stethoscope, that digitally records (heart) sounds.

The digital recording is transmitted electronically to a remote DHMRS computer facility, and loaded to a relational database, including identifiers for doctor, patient, and date/time of the exam. In the relational database, the digital recording and identifiers are associated with additional patient data included in related records, also keyed to doctor and date/time, as well as patient and date/time. The additional patient data could include tentative diagnosis, symptoms, general self-reported health, doctor's sound description (e.g. location, intensity, description), doctor's past and present prescribed treatment, patient heart history and the reason for seeking medical attention (the iatrotrophic stimulus).

The digital record is collected for each use of the stethoscope, the recording and identifying data transmitted to the DHMRS computer at the end of the doctor's workday. Electronic transmission could be by wired or wireless communication systems, or by recordation on magnetic or optical media with transfer to the DHMRS computer by a peripheral device for reading such media. Because the electronics are inherently more sensitive than the human ear to both very low and very high frequencies, it may be possible to correlate previously unperceived changes in heart sounds with changes in other measures of health, or with various drug or behavioral changes affecting the patient. The DHMRS includes algorithms for analyzing the sound (producing a sound map for each session, each map being a static metric), algorithms for comparing one sound map with another (dynamic metrics), and statistical algorithms for compiling a database of dynamic metrics (a database of how static metrics changed from one examination to the next, explicitly including a measure of the elapsed time between examinations).

The DHMRS can also compare the dynamic metrics for a particular patient (a sequence of examinations, and changes between examinations) with the dynamic metrics for a relevant comparison population of similar patients in the database. This comparison allows for a more accurate prediction of the likely course of health for this metric system (heart health metrics as revealed by electronic stethoscope examination). This comparison allows a more accurate prediction of the likely effect of drug or surgical interventions, based on the growing experience recorded in the dynamic metric database. The comparison could be sent to the physician or managed care organization (MCO) in the form of a standardized report, transmitted electronically. The longer the database is maintained, and the larger the number of patients included, the more useful and accurate it will be for assisting doctors in diagnostic, prognostic, and management evaluations and decisions.

### EXAMPLE 2

### Dynamic Health Metric Reporting System for Palpation Data Related to the Breast

In this embodiment the dynamic health metric reporting system (DHMRS) prospectively collects data from doctors, who may be using a robotic device for detecting anomalies in breast tissue. One apparatus for detecting tissue anomalies, illustrated in U.S. Pat. No. 6,192,143, maps characteristics of breast tissue, such as density, in three dimensions, recording the data digitally for later inspection and comparison. The digital recording is transmitted electronically to a remote DHMRS computer facility, and loaded to a relational database, including identifiers for doctor, patient, and date/time of the exam. In the relational database, the digital recording and identifiers are associated with additional patient data included in related records, also keyed to doctor and date/time, as well as patient and date/time. The additional patient data could include tentative diagnosis, symptoms, general self-reported health, doctor's description of the breast by visual and manual inspection, doctor's past and present prescribed treatment, personal and family history and the reason for seeking medical attention (the iatrotrophic stimulus).

The digital record is collected for each -use of the apparatus for detecting anomalies in breast tissue, the recorded and identifying data transmitted to the DHMRS computer at the end of the doctor's workday. The electronic transmission could be by wired or wireless communication systems, or by recordation on magnetic or optical media with transfer to the DHMRS computer by a peripheral device for reading such media.

Because a palpation probe of the apparatus is inherently more sensitive than the human hand for detecting tissue anomalies, and because the optical mapping system of the apparatus is more precise than the human eye, it is possible to detect previously unperceived changes in breast tissue characteristics, such as density, and to correlate the changing characteristics with the development of breast abnormalities and their associated health implications, such as fibrocystic changes or cancer. The DHMRS tracks and analyzes changes in breast tissue characteristics following surgical or drug treatment. The DHMRS includes algorithms for analyzing breast tissue characteristics, such as density (producing a breast density map for each session, each map being a static metric), algorithms for comparing one breast map with another (dynamic metrics), and statistical algorithms for compiling a database of dynamic metrics (a database of how static metrics changed from one examination to the next, explicitly including a measure of the elapsed time between examinations and drug or surgical treatments between examinations).

The DHMRS compares the dynamic metrics for a particular patient (a sequence of examinations, and changes between examinations) with the dynamic metrics for a relevant comparison population of similar patients in the database. This comparison allows for more accurate prediction of the likely course of health for this metric system (breast health metrics as revealed by robotic breast palpation examination). The comparison allows more accurate prediction of the likely effect of drug or surgical interventions, based on the growing experience recorded in the dynamic metric database. The comparison can be sent to the physician or managed care organization (MCO) in the form of a standardized report, preferably via electronic transmission. The longer the database is maintained, and the larger the number of patients included, the more useful and accurate the DHMRS will be for assisting doctors in diagnostic, prognostic, and management evaluations and decisions.

### EXAMPLE 3

### Dynamic Health Metric Reporting System (DHMRS) for CEA Levels, Related to Monitoring the Efficacy of Cancer Treatment

In this embodiment, the dynamic health metric reporting system (DHMRS) collects data prospectively from doctors or clinical laboratories, concerning the blood levels of Carcino Embryonic Antigen (CEA). In this example, the CEA level is a single number, together with a standard deviation for the measurement.

CEA can be a useful marker for the presence of cancer. In particular, if a patient is diagnosed with cancer, particularly colorectal cancer, tracking the level of CEA provides a means for monitoring the efficacy of treatment, which can be assessed by the drop in CEA levels towards normal. Subsequent elevations in CEA, after a drop, are frequently thought to indicate recurrence or metastasis of the cancer. However, judging the significance of a small rise, or the persistence of a rise, or the speed of decline in CEA level, is the subject of current debate.

The DHMRS records the CEA level (and standard deviation), along with other relevant clinical data about the patient, and statistically sorts significant trends. A digital record of the CEA level and standard deviation is transmitted electronically to a remote DHMRS computer facility, and loaded to a relational database, including identifiers for doctor, patient, and date/time of the exam. In the relational database, the digital record and identifiers are associated with additional patient data included in related records, also keyed to doctor and date/time, as well as patient and date/time. The additional patient data could include tentative diagnosis, symptoms, general self-reported health, doctor's description of the cancer history, doctor's past and present prescribed treatment, personal and family cancer history and the reason for seeking medical attention (the iatrotrophic stimulus).

The digital record is collected for each CEA level detected. The electronic transmission could be wired or wireless communication systems, or by recordation on magnetic or optical media with transfer to the DIMRS computer by a peripheral device for reading such media. Because the CEA data is placed in the database prospectively, over very large numbers of patients, the DHMRS is able to statistically detect previously unperceived patterns of change in CEA levels, correlating them with the progression or remission of cancer.

The DHMRS tracks and analyzes changes in CEA levels following surgical or drug treatment. The DHMRS includes algorithms for comparing one CEA level with another (dynamic metrics), and statistical algorithms for compiling a database of dynamic metrics (a database of how static metrics changed from one examination to the next, explicitly including a measure of the elapsed time between examinations and drug or surgical treatments occurring therebetween).

The DHMRS compares the dynamic metrics for a particular patient (a sequence of examinations, and changes between examinations) with the dynamic metrics for a relevant comparison population of similar patients in the database. This comparison allows for more accurate prediction of the likely course of health for this metric system (CEA levels after detection of cancer). The comparison allows more accurate prediction of the likely effect of drug or surgical interventions, based on the growing experience recorded in the dynamic metric database. The comparison can be sent to the physician or managed care organization (MCO) in the form of a standardized report, through electronic transmission. The longer the database is maintained, and the larger the number of patients included, the more useful and accurate the DHMRS will be for assisting doctors in diagnostic, prognostic, and management evaluations and decisions.

General Discussion:

In a preferred embodiment of the invention, features include the collection and storage of digital examination data. In this embodiment, the database is prospective (i.e., examination data, demographic and treatment data, etc., is collected and stored at the time of occurrence). The database is also relational, providing sort and search capability for all included criteria. The system includes statistical algorithms, clinical epidemiology, meta-analytical techniques, including the capability to compare an individual patient's dynamic data with subgroups in, and the totality of, the database. The report generating logic provides report generation capability relative to and sorted by a variety of criteria.

The DHMRS could further be directed to digital maps of any kind, density, x-ray, sonogram, thermal, CT Scan, MRI, PET, and radiographic contrast. Graphs of electrical activity electrocardiogram, electroencephalogram and nerve conduction would also be adaptable to the methods and system of the present invention. Also, sound recordings, such as the digital stethoscope described above, and bone conduction studies are applicable. A reporting system could be developed for images obtained by systematic computer reading, histologically or immuno-histologically stained slides, and histograms of lab work (including complete blood counts). Any observations of the body where direct output is digital or numerical, such as lab values (e.g., CEA, PSA, free PSA), or observations where direct output is analog, but can be digitized (e.g., mammogram), are also adaptable. In short, any examination data having an objective, measurable outcome could be the subject of a dynamic health metric reporting system.

What is claimed is:

1. A method for developing a health reporting system, comprising the steps of:
a. collecting examination data for each of multiple examinations of subject bodies;
b. storing the examination data in a database;
c. comparing examination data from two or more specific examination dates for an identical subject body;
d. characterizing differences between the examination data from two or more examination dates for the identical subject body;
e. storing the differences in a database; and
f. generating a report detailing the differences in the examination data between two or more examination dates for the identical subject body, whereby the report assists in predicting a likely course of health for the subject body.

2. The method of claim 1, wherein collecting examination data occurs by receiving, from remote locations, electronically transmitted examination data.

3. The method of claim 1, wherein the examination data results from medical device detection.

4. The method of claim 1, wherein the examination data collected is digitally encoded.

5. The method of claim 1, wherein the examination data collected further includes identifiers for doctor, the subject body and the date and time of the examination.

6. The method of claim 1, wherein the examination data collected further includes individual demographic, clinical, and treatment data of the subject body.

7. The method of claim 1, wherein the database is a relational database.

8. The method of claim 1, wherein the database further includes demographic, treatment, clinical, pathological, and historical data of the subject body.

9. The method of claim 1, wherein the report further includes elapsed time between examination dates and drug or surgical treatments occurring between examination dates.

10. The method of claim 1, further including the step of creating a difference map, the difference map mapping the differences between the examination data from two different examination dates, and filing the difference map with respective examination information in a database.

11. The method of claim 10, wherein changes in examination data between different examination dates, and difference maps created therefrom, are stored by individual subject body in a database.

12. The method of claim 11, further including the step of generating a report detailing records of changes in history, treatment, demographics, pathology diagnosis, demographics, difference maps, times between examination dates and examination sequence.

13. The method of claim 11, further including the step of generating a report relating changes in difference maps to changes in clinical or pathological data, by time between difference maps.

14. The method of claim 1, wherein the examination data is directed to auditory data related the heart.

15. The method of claim 1, wherein the examination data is directed to characteristics of tissue.

16. The method of claim 15, wherein the characteristics of tissue are detected by an apparatus for detecting anomalies in tissue.

17. The method of claim 16, wherein the tissue is human breast tissue.

18. The method of claim 1, wherein the examination data is directed to CEA levels.

19. The method of claim 18, wherein characterizing and reporting differences in CEA levels is related to monitoring the efficacy of cancer treatment.

20. The method of claim 8, wherein changes in examination data between different examination dates are stored by individual subject body, for a plurality of subject bodies, in a database.

21. The method of claim 8, further comprising the step of performing a meta-analysis of changes in examination data between different examination dates by one or more criteria selected from the group consisting of demographic, treatment, clinical, pathological and historical data.

22. The method of claim 21, further comprising the step of generating a report detailing group correlations and meta-analysis and providing the report to physicians or managed care organizations to assist in diagnostic, prognostic and management evaluations and decisions.

23. The method of claim 21, further comprising the step of using meta-analysis data to inform populations through intervention, prevention and screening strategies.

24. The method of claim 1, further comprising the step of scanning the database for certain criteria for selecting pertinent patients, based upon the characterized differences, for clinical trials.

25. The method of claim 20, further comprising the step of characterizing differences between the examination data from two or more examination dates for the subject body in relation to changes in one or more criteria occurring between the respective examination dates, the criteria selected from the group consisting of demographic, treatment, clinical, pathological and historical data.

26. The method of claim 25, further comprising the step storing the characterized differences for the subject body in a relational database.

27. A method for developing a dynamic health metric reporting system, comprising the steps of:
a. collecting examination data for each of multiple examinations of subject bodies;
b. storing the examination data in a database;
c. comparing examination data from two or more specific examination dates for an identical subject body, creating one dynamic metric for the subject body for each pair of examination dates compared;
d. storing the one or more dynamic metrics created for the subject body in a database;
e. comparing the one or more dynamic metrics for the subject body with dynamic metrics for a relevant comparison population of similarly situated subject bodies in the database; and
f. generating a report detailing the similarities and differences in the dynamic metrics for the subject body with the dynamic metrics of similarly situated subject bodies in the database, whereby the report assists in predicting a likely course of health for the subject body.

28. The method of claim 14, wherein the dynamic metric includes changes in examination data and other relevant data of occurrences between the respective examination dates.

29. The method of claim 15, wherein the other relevant data of occurrences includes drug or surgical interventions, whereby the report assists in predicting a likely effect of drug or surgical intervention, based upon the statistical record included in the database.

30. The method of claim 16, further including the step of providing the report to a physician or managed care provider to assist in predicting a likely effect of drug or surgical intervention on the subject body.

31. The method of claim 14, further including the step of providing the report to a physician or managed care provider to assist in diagnostic, prognostic and management evaluations and decisions regarding the subject body.

32. The method of claim 27, wherein the examination data is directed to auditory data related the heart.

33. The method of claim 27, wherein the examination data is directed to characteristics of tissue.

34. The method of claim 33, wherein the characteristics of tissue are detected by an apparatus for detecting anomalies in tissue.

35. The method of claim 34, wherein the tissue is human breast tissue.

36. The method of claim 27, wherein the examination data is directed to CEA levels.

37. The method of claim 36, wherein characterizing and reporting differences in CEA levels is related to monitoring the efficacy of cancer treatment.

38. The method of claim 27, wherein the database further includes demographic, treatment, clinical, pathological, and historical data of the subject bodies.

39. The method of claim 38, further comprising the step of performing a meta-analysis of dynamic metrics in relation to one or more criteria selected from the group consisting of demographic, treatment, clinical, pathological and historical data.

40. The method of claim 39, further comprising the step of generating a report detailing group correlations or meta-analysis and providing the report to physicians or managed care organizations to assist in diagnostic, prognostic and management evaluations and decisions.

41. The method of claim 39, further comprising the step of using meta-analysis data to inform populations through intervention, prevention and screening strategies.

42. The method of claim 27, further comprising the step of scanning the database for certain criteria for selecting pertinent patients, based upon the characterized differences, for clinical trials.

43. The method of claim 27, further comprising the step of characterizing differences between the examination data from two or more examination dates for the subject body in relation to changes in one or more criteria occurring between the respective examination dates, the criteria selected from the group consisting of demographic, treatment, clinical, pathological and historical data.

44. The method of claim 43, further comprising the step storing the characterized differences for the subject body in a relational database.

45. A method for developing a breast tissue density reporting system, comprising the steps of:
a. collecting breast tissue density values for each of multiple examinations of subject bodies;
b. storing the breast tissue density values in a database; comparing breast tissue density values from two or more specific examination dates for an identical subject body;
c. characterizing differences between the breast tissue density values from two or more examination dates for the identical subject body;
d. storing the differences in a database; and
e. generating a report detailing the differences in the breast tissue density values between two or more examination dates for the identical subject body, whereby the report assists in predicting a likely course of health for the subject body.

46. A method for developing a dynamic health metric reporting system for breast tissue density, comprising the steps of:
a. collecting breast tissue density values in three dimensions, determined for each of multiple examinations of subject bodies;
b. storing the breast tissue density values in a database; comparing breast tissue density values from two or more specific examination dates for an identical subject body, creating one dynamic metric for the subject body for each pair of examination dates compared;
c. storing the one or more dynamic metrics created for the subject body in a database;
d. comparing the one or more dynamic metrics for the subject body with dynamic metrics for a relevant comparison population of similarly situated subject bodies in the database; and
e. generating a report detailing the similarities and differences in the dynamic metrics for the subject body with the dynamic metrics of similarly situated subject bodies in the database, whereby the report assists in predicting a likely course of health for the subject body.

47. A computer-readable medium that configures a computer to perform a method for developing a health reporting system, the method comprising the steps of:
a. collecting examination data for each of multiple examinations of subject bodies;
b. storing the examination data in a database; comparing examination data from two or more specific examination dates for an identical subject body;
c. characterizing differences between the examination data from two or more examination dates for the identical subject body;
d. storing the differences in a database; and
e. generating a report detailing the differences in the examination data between two or more examination dates for the identical subject body, whereby the report assists in predicting a likely course of health for the subject body.

48. A computer-readable medium that configures a computer to perform a method for developing a dynamic health metric reporting system, the method comprising the steps of:
a. collecting examination data for each of multiple examinations of subject bodies;
b. storing the examination data in a database;
c. comparing examination data from two or more specific examination dates for an identical subject body, creating one dynamic metric for the subject body for each pair of examination dates compared;
d. storing the one or more dynamic metrics created for the subject body in a database;
e. comparing the one or more dynamic metrics for the subject body with dynamic metrics for a relevant comparison population of similarly situated subject bodies in the database; and
f. generating a report detailing the similarities and differences in the dynamic metrics for the subject body with the dynamic metrics of similarly situated subject bodies in the database, whereby the report assists in predicting a likely course of health for the subject body.

49. A computer-readable medium that configures a computer to perform a method for developing a breast tissue density reporting system, the method comprising the steps of:
a. collecting breast tissue density values for each of multiple examinations of subject bodies;
b. storing the breast tissue density values in a database; comparing breast tissue density values from two or more specific examination dates for an identical subject body;
c. characterizing differences between the breast tissue density values from two or more examination dates for the identical subject body;
d. storing the differences in a database; and
e. generating a report detailing the differences in the breast tissue density values between two or more examination dates for the identical subject body, whereby the report assists in predicting a likely course of health for the subject body.

50. A computer-readable medium that configures a computer to perform a method for developing a dynamic health metric reporting system for breast tissue density, the method comprising the steps of:
a. collecting breast tissue density values in three dimensions, determined for each of multiple examinations of subject bodies;
b. storing the breast tissue density values in a database;
c. comparing breast tissue density values from two or more specific examination dates for an identical subject body, creating one dynamic metric for the subject body for each pair of examination dates compared;
d. storing the one or more dynamic metrics created for the subject body in a database;
e. comparing the one or more dynamic metrics for the subject body with dynamic metrics for a relevant comparison population of similarly situated subject bodies in the database; and
f. generating a report detailing the similarities and differences in the dynamic metrics for the subject body with the dynamic metrics of similarly situated subject bodies in the database, whereby the report assists in predicting a likely course of health for the subject body.

51. A computer-readable medium that stores a program for developing a health reporting system, the program comprising:
a. means for collecting examination data for each of multiple examinations of subject bodies;
b. means for storing the examination data in a database; means for comparing examination data from two or more specific examination dates for an identical subject body;
c. means for characterizing differences between the examination data from two or more examination dates for the identical subject body;
d. means for storing the differences in a database; and
e. means for generating a report detailing the differences in the examination data between two or more examination dates for the identical subject body, whereby the report assists in predicting a likely course of health for the subject body.

52. A computer-readable medium that stores a program for developing a dynamic health metric reporting system, the program comprising:
a. means for collecting examination data for each of multiple examinations of subject bodies;
b. means for storing the examination data in a database;
c. means for comparing examination data from two or more specific examination dates for an identical subject body, creating one dynamic metric for the subject body for each pair of examination dates compared;
d. means for storing the one or more dynamic metrics created for the subject body in a database;
e. means for comparing the one or more dynamic metrics for the subject body with dynamic metrics for a relevant comparison population of similarly situated subject bodies in the database; and
f. means for generating a report detailing the similarities and differences in the dynamic metrics for the subject body with the dynamic metrics of similarly situated subject bodies in the database, whereby the report assists in predicting a likely course of health for the subject body.

53. A computer-readable medium that stores a program for developing a breast tissue density reporting system, the program comprising:
a. means for collecting breast tissue density values for each of multiple examinations of subject bodies;
b. means for storing the breast tissue density values in a database; means for comparing breast tissue density values from two or more specific examination dates for an identical subject body;
c. means for characterizing differences between the breast tissue density values from two or more examination dates for the identical subject body; means for storing the differences in a database; and
d. means for generating a report detailing the differences in the breast tissue density values between two or more examination dates for the identical subject body, whereby the report assists in predicting a likely course of health for the subject body.

54. A computer-readable medium that stores a program for developing a dynamic health metric reporting system for breast tissue density, the program comprising:
a. means for collecting breast tissue density values in three dimensions, determined for each of multiple examinations of subject bodies;
b. means for storing the breast tissue density values in a database;
c. means for comparing breast tissue density values from two or more specific examination dates for an identical subject body, creating one dynamic metric for the subject body for each pair of examination dates compared;
d. means for storing the one or more dynamic metrics created for the subject body in a database;
e. means for comparing the one or more dynamic metrics for the subject body with dynamic metrics for a relevant comparison population of similarly situated subject bodies in the database; and
f. means for generating a report detailing the similarities and differences in the dynamic metrics for the subject body with the dynamic metrics of similarly situated subject bodies in the database, whereby the report assists in predicting a likely course of health for the subject body.
